(19) United States
(12) Patent Application Publication
(10) Pub. No.: US 2024/0325902 A1
(43) Pub. Date: Oct. 3, 2024

(54) DYNAMIC INDICATIONS OF NAVIGATION ASSIST IN VIRTUAL INTERACTIVE ENVIRONMENTS

(71) Applicant: Electronic Arts Inc., Redwood City, CA (US)

(72) Inventor: Nicholas Jeffrey Berry, Moonee Ponds (AU)

(21) Appl. No.: 18/622,649

(22) Filed: Mar. 29, 2024

Related U.S. Application Data
(60) Provisional application No. 63/455,714, filed on Mar. 30, 2023.

(51) Int. Cl. A63F 13/5375; A63F 13/54; A63F 13/79

(52) U.S. Cl. CPC A63F 13/5375; A63F 13/54; A63F 13/79

(57) ABSTRACT

Systems and methods are presented herein from providing assist indication in an interactive virtual environment. Game data of a game session of a virtual interactive environment is received. Based in part on the game data, a navigation assist used in the game session is identified. An assist indication to render is determined based on the game data and the navigation assist. The assist indication is configured for rendering during runtime. The assist indication is rendered in the virtual interactive environment of the game session.

### CROSS REFERENCE TO RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

Existing software, such as video games, includes virtual interactive environments which characters or objects, operated or controlled by users, navigate in or through. Such software often includes navigation assists that provide visual assistance to help users (and/or their respective virtual characters or objects) navigate, maneuver, or explore virtual interactive environments. Navigation assists are generally provided in the form of visual cues, aids, information, context, and the like. Existing navigation assists often fail to convey sufficient or optimal information to adequately aid players, or provide a navigation assist that is not usable or optimal for all players. For instance, some players may not wish to consume visual navigation assist or may not be able to do so due to a mismatch between their abilities and their environment. Accordingly, there is a need for systems and methods that dynamically provide indications of navigation assists in real-time to further aid users by conveying supplemental contextual information corresponding to the navigation assist to enhance gameplay accessibility.

### BRIEF DESCRIPTION OF THE DRAWINGS

This disclosure will be more fully understood from the following detailed description taken in conjunction with the accompanying drawings, in which:

FIG. 1 is a system diagram of a gaming environment according to an example embodiment;

FIG. 2 is a diagram of an assist indication system for providing assist indication according to an example embodiment;

FIG. 3 is a flow diagram of a process to configure real-time assist indication systems according to an example embodiment;

FIG. 4 is a diagram of a virtual interactive environment according to an example embodiment; and

FIG. 5 is a diagram of an example computing device usable to perform any of the methods described herein, including for real-time assist indication.

### DETAILED DESCRIPTION

The systems and methods described herein dynamically provide real time indications to navigation assists in virtual interactive environments. As used herein, and as will be described in further detail below, providing real-time indications of navigation assists (hereinafter “assist indication” in short) can include determining, calculating and/or generating auditory and/or visual assist indication data, and outputting it (or causing it to be output) at a user's computing device during a gaming session to supplement navigation assists.

As known to those of skill in the art, providing “dynamic” or “real-time” assistance refers to the process of generating or starting the process of generating the assistance (e.g., auditory cucs) immediately or substantially immediately (e.g., within 1 ms, 10 ms, 100 ms, etc.) upon receiving data and/or commands triggering the assistance.

It should be understood that an indication or “assist indication” (e.g., assist indication information) to a navigation assist can be or include auditory (e.g., beeps, alarms, sirens, whirrs, buzzes, etc.), visual (e.g., map, compass, waypoint, path lines, lights, arrows, etc.), and/or haptic (vibrations, pulses, etc.) cues or aids that are provided or output (e.g., to a user or player, via a corresponding output device) during runtime—for example, during gameplay of a video game.

The type (e.g., auditory, visual, haptic) and/or configuration of an assist indication can be based in part on or more user configurable settings and/or accessibility settings (e.g., user configuration data) of a video game, in addition game data. In this way, the assist indication can conform to those settings of a user, or set by a user, to ensure they are most usable or accessible to the user. For example, a configuration can ensure an assist indication is not too loud, bright, intense, subtle, or of particular colors.

For simplicity, the present disclosure provides examples, illustrations, and descriptions of auditory assist indications, but other forms of assistant indications including visual and haptic outputs are applicable. Furthermore, as a non-limiting illustrative example in some embodiments herein, “path lines” and “path line indication” are used as examples of navigation assists and assist indication, respectively.

In racing video games, a path line is commonly referred to as a “racing line”. Racing lines and other forms of path lines are typically configured as dynamic or adaptive in-game features that correspond to game data of a video game. A path line can represent a desired, preferable, or optimal trajectory within the virtual interactive environment.

Path lines are commonly generated, simulated, and/or rendered during gameplay based in part on game data corresponding to the state, simulation, and/or characteristics of one or more virtual interactive environments, player characters, non-player characters, and/or game objects or virtual objects. As such, a path line indication, which is a form of assist indication, can be based in part on similar game data corresponding to one or more of the following: navigation assists, such as path lines, user configurable settings, and/or accessibility settings of a video game.

Providing or rendering an assist indication results in (providing) supplemental and/or contextual navigation information intended to guide or assist a player-controlled character or object to or towards a navigation assist (e.g., a path line), or portion thereof. As described herein, assist indications can be visual or non-visual, meaning that it can, but need not, include visual assist indication information.

### Gaming Environment

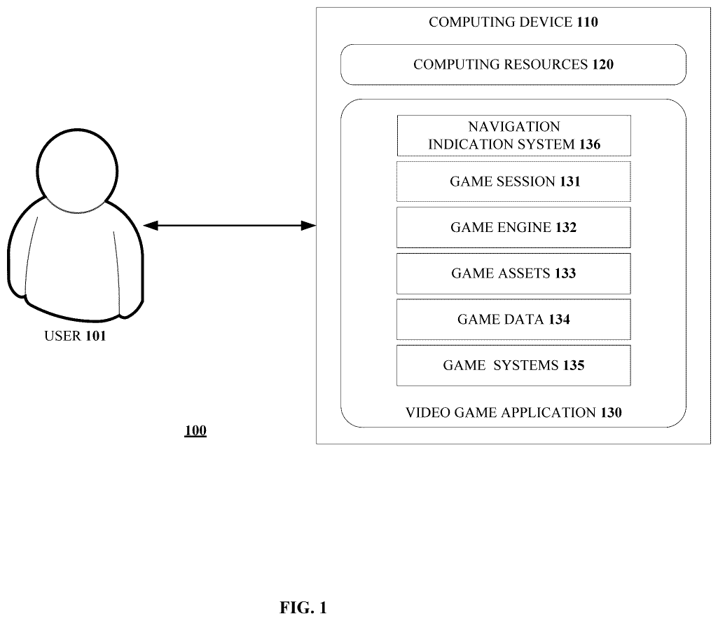

FIG. 1 is a system diagram of a gaming environment 100 according to an example embodiment. As described herein, the gaming environment 100 enables users to execute and/or play video games through their computing devices. As shown in FIG. 1, the environment 100 includes a computing device 110 that is associated with—or operated and/or controlled by—a user 101 (also referred to herein interchangeably as “player” or “player 101”). As known to those of skill in the art, the user 101 can operate or control the computing device 110 through inputs provided via input devices of or associated with the computing device 110.

The computing device 110 can be or include any one or a combination of systems known to those of skill in the art. For example, the computing device 110 can be or include a desktop, laptop, game application platform, game console, virtual reality system, augmented reality system, television set-top box, television, network-enabled kiosk, car-console devices computerized appliance, wearable device (e.g., smart watch, glasses with computing functionality), and wireless mobile devices (e.g., smart phones, PDAs, tablets).

The computing device 110 includes hardware and software components, such as those described herein, that can be used to execute or play a video game application. As illustrated in example FIG. 1, the computing device 110 includes computing resources 120. The computing resources 120 may be or include, for example, central processing units (CPUs) and architectures, memory, mass storage, graphics processing units (GPUs), communication or networking components, input devices and/or output devices. It should be understood that the computing device 110 can include any number and/or combination of computing resources, including those described herein and others known to those of skill in the art.

In some embodiments, the user 101 can provide inputs to the computing device 110 through one or more of the input devices (e.g., controller, keyboard, mouse, touchscreen, camera, microphone, etc.) associated with the computing device 110. The computing device 110 can output, communicate and/or provide information (e.g., display, render, play audio) to the user 101 through one or more of the output devices (e.g., monitor, screen, touchscreen, speaker, etc.) associated with the computing device 110.

The example computing device 110 can store and/or execute computer executable instructions (or code). In some embodiments, these instructions can make up or form applications (or programs or software), such as video game applications, interactive applications, and/or other applications known to those of skill in the art that could include or benefit from assist indication such as that described herein. Different applications can be made up of varying instructions, components, graphical configurations, and/or data for supporting their runtime execution on different hardware (e.g., different types of computing devices).

As illustrated in FIG. 1, the computing device 110 includes a video game application 130. The video game application 130 (and other instructions of or stored on the computing device 110) can be stored and/or executed locally and/or in a distributed environment. As known to those of skill in the art, in a locally executed implementation, the video game application 130 does not rely on or utilize an external computing device (e.g., a system other than the computing device 110) to execute the game. In some instances, a locally executable video game application can communicate with external systems or devices, such as external servers, to retrieve information associated with the video game, such as game patches, game authentication, cloud saves, user account data, previously trained model data, or other features.

In distributed implementations, the computing device 110 may execute portions of the video game application 130, while other systems or devices such as external servers execute other portions of the video game application 130. For instance, massively multiplayer online role-playing games (MMORPGs) include client portions (e.g., video game application) of the video game executed by computing devices of or corresponding to users or players, and server portions executed by one or more servers. It should be understood that the video game application 130 described herein can be a locally executable game or a distributed application.

Still with reference to FIG. 1, the video game application 130 includes, is associated with and/or is made up of parts, components, or modules. Each of these parts, components or modules can be or include instructions or code that's executable by the computing device 110. For instance, as shown in FIG. 1, the video game application 130 can include game sessions 131, game engine 132, game assets 133, game systems 135, game data 134 and an assist indication system 136.

Executing the video game application 130 can cause an instance of the video game to be generated. Each instance can be referred to as a “game session.” The game session 131 of FIG. 1 is an instance of the video game and can be made up of or include one or more virtual interactive environments. The virtual interactive environment can be or include one or more virtual levels and/or graphical user interfaces that can be interacted with or in, for instance, at an interactive virtual arca or virtual space, for purposes of gameplay or socializing. The game session 131, and or its game levels or virtual spaces, can include, host, or enable participation and interaction by or with player characters, non-player characters, quests, objectives, and other virtual features, elements, assets, objects or the like known to those of skill in the art. In some embodiments, the game session 131 includes, leverages, and/or is produced and/or maintained in part by or using game data 134.

The game session 131 can include or have associated therewith various game assets, such as player characters and/or non-player characters. As known to those of skill in the art, player characters are character models that can be controlled or directed (at least primarily) by users or players through inputs at their respective computing devices and can perform gameplay actions or commands. “Non-player characters” (also referred to herein as “NPCs”) are characters that are not or cannot be controlled and/or directed (primarily by users or players. Rather, NPCs can be configured with computer executable instructions to perform one or more gameplay tasks and/or actions, with and/or without the need for input or interaction from a user/player or player character.

The game session 131 can include a number of objects, including player objects (or “player controlled objects”). Player objects and/or virtual objects can refer to controllable objects, or models, used to facilitate or enable gameplay or other in-game actions. Player objects may be, for example, vehicles, vessels, aircraft, ships, tiles, cards, dice, pawns, and other similar items known to those of skill in the art. In some embodiments, a user or player can control or direct one or more player objects in game session 131, including, for example, by controlling player characters and/or virtual objects which in turn causes associated objects to be controlled.

For purposes of simplicity, player characters, player objects, or virtual objects otherwise corresponding to a player and/or gameplay may be referred to herein collectively as player characters, and the terms may be used and/or interchanged synonymously. It should be understood that, as used herein, “controllable” refers to the characteristic of being able and/or configured to be controlled and/or directed (e.g., moved, modified, etc.) by a player or user through one or more inputs provided via an input device such as a controller.

The video game application 130 also includes game data 134. The game data can include state data, simulation data, rendering data, and other data as known to those of skill in the art.

State data can include data that describes or defines the state of characters, objects, entities or other aspects of virtual interactive environments or virtual levels. The states of state data can be associated with time instances or periods during a game session of a video game. For example, state data can include the location and condition of a character in a virtual interactive environment at a specific time period, frame, duration of time or number of frames.

Simulation data can include the data that drives the simulation (physics and other mechanics) of a model (e.g., character model, object model) of the game in the game engine. For example, the simulation data can include the joint and structural configuration of a character model and corresponding physical forces or characteristics applied to it at a specific point in time during gameplay. This information can be used to create animations in the game.

Render data can include data for visual and auditory rendering of aspects of the game session, for output to an output device. For example, the render data can include data corresponding to the rendering of graphical, visual, auditory, and/or haptic outputs of a video game.

In some embodiments, the game data 134 can serve as the basis of or for the gameplay session 131; that is, the game data can be used for runtime execution of the game session 131 of the video game application 130. During the runtime execution of the video game application 130 (e.g., in a game session 131), aspects of the game (gameplay events, objectives, triggers, and other aspects, objects, or elements) can use, cause, produce, generate, and/or modify game data 134 or portion thereof. In some embodiments, game data 134 includes data produced or generated over the course of a number of game sessions.

The game data 134 may be updated, versioned, and/or stored periodically as one or multiple files to a memory or storage device associated with the video game application 130, which can be local or remote. The game data 134, or copies and/or portions thereof, can be stored, referenced, categorized, or placed into a number of buffers or storage buffers.

The game engine 132 includes instructions configured to enable the execution of the video game application 130 (e.g., the game code). Although not illustrated, the game engine 132 can include, among other things, a renderer, simulator, and stream layer. In some embodiments, the game engine 132 uses game data (e.g., state data, render data, simulation data, audio data) to generate and/or render one or more outputs of the video game. These outputs can be visual, audio and/or haptic outputs that are communicated or provided to the user 101 via output devices of or associated with the computing device 110. The renderer can provide a graphics framework for managing the production of graphics including with respect to lighting, shadows, textures, user interfaces, other effects, game assets, and the like. The simulator can provide a framework for managing physics and other mechanics used in part for animations and/or interactions of gameplay objects, entities, characters, lighting, gasses, other game assets or effects, and the like. The stream layer makes it possible or easier for the renderer and simulator to execute independently of one another, by providing a common execution stream for renderings and simulations to be produced and/or synchronized at and/or during runtime. For example, the renderer and simulator of the game engine 132 can execute at different rates (e.g., ticks, clocks) and have their respective outputs synchronized by the stream layer.

The game engine 132 can include an audio engine or audio renderer that produces and synchronizes audio playback with or among the common execution of a stream layer. In some embodiments, an audio engine of game engine 132 can use game data to produce audio output and/or haptic output. In some embodiments, an audio engine of game engine 132 can transcribe audio data or text data to produce audio haptic output. Haptic output or haptic signal output includes signal data of duration, intensity, and/or frequency.

The game systems 135 are the game code or game logic that compose the video game application 130. The game systems 135 include instructions configured to provide, facilitate and/or manage the gameplay (including gameplay features and aspects) of the video game application 130. In some embodiments, the game systems 135—alone or in conjunction with other aspects of the game application 130 and/or the computing device 110—produce, generate and/or maintain the gameplay in an instance of a video game application (e.g., a game session).

The game assets 133 are digital assets of or corresponding to the video game application 130. In some embodiments, the game assets 133 can include virtual objects, character models, actors, entities, geometric meshes, textures, terrain maps, animation files, audio files, digital media files, font libraries, visual effects, and other digital assets commonly used in video games of the like. As such, game assets 133 are the data files used in part to produce the runtime of the video game application 130, such as its virtual interactive environments, menus, characters, objects, and the like. In some embodiments, game engine 132 and/or game systems 135 reference game assets 133 to produce game session 131, including the characters and objects associated therewith.

The video game application 130 can also include an assist indication system 136, as shown in FIG. 1. In some embodiments, the assist indication system 136 includes code or instructions configured to provide assist indication in a virtual interactive environment.

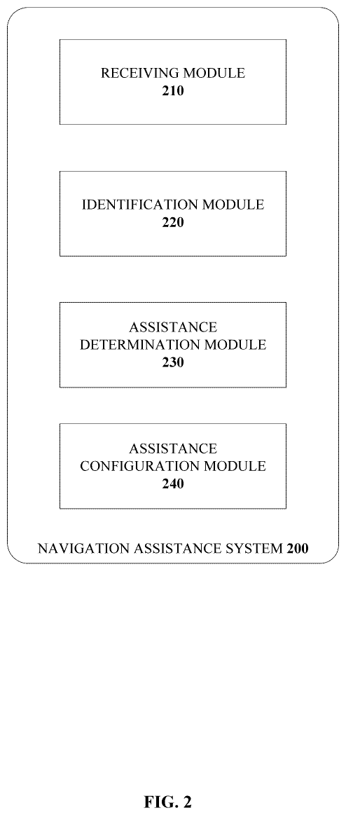

FIG. 2 is a diagram of a navigation assistance system 200 for providing assist indications according to an example embodiment. In some embodiments, the navigation assistance system 200 can correspond in whole or in part to the assist indication system 136 of FIG. 1. As shown, the navigation assistance system 200 can include a receiving module 210, an identification module 220, an assistance determination module 230, and an assistance configuration module 240.

Receiving module 210 of navigation assistance system 200 includes computer executable instructions configured to receive, request, and/or access game data of a video game application, similar to video game application 130 of FIG. 1. In some embodiments, the game data received, requested, and/or accessed by receiving module 210 includes or corresponds to one or more navigation assists.

A video game application can send game data to navigation assistance system 200 or receiving module 210. For example, a video game application can send game data to receiving module 210 periodically or at one or more instances during gameplay, such as when render data corresponding to a navigation assist is among a pipeline of a game engine (e.g., when an assist indication is rendered or to be rendered among a virtual interactive environment).

The receiving module 210 and/or navigation assistance system 200 can request and/or access game data from a video game application. For example, the receiving module 210 can request and/or access game data when render data corresponding to a navigation assist is among a pipeline of a game engine.

Identification module 220 of navigation assistance system 200 includes computer executable instructions configured to identify one or more navigation assists—and/or one or more characteristics or properties of a navigation assists-among game data received, requested, and/or accessed by receiving module 210.

For example, identification module 220 can identify that a “path line” is among the game data during gameplay, as well as identify characteristics corresponding to the path line; such as the length, color, size, location, opacity, and other characteristics of the like. In some embodiments, the characteristics or properties of a navigation assist correspond to the visual, auditory, and/or haptic output of the navigation assist; such as, but not limited to, the size, location, opacity, color, duration, intensity, pitch, and volume, among other things.

Assistance determination module 230 of navigation assistance system 200 includes computer executable instructions configured to determine an assist indication based at least in part on the game data received by receiving module 210 and/or the navigation assist identified by identification module 220.

Assistance determination module 230 can be configured with deterministic logic to determine which assist indication type would best supplement, compliment, extend or otherwise convey more contextual information to a user, based in part on the game data. For example, Assistance determination module 230 can be configured to determine that an auditory and/or haptic assist indication type should be used when a visual type of navigation assist is being rendered among a virtual interactive environment, so that the output corresponding to the assist indication supplements the navigation assist.

Assistance determination module 230 can also determine an assist indication based in part on one or more settings corresponding to a user and/or a video game application, similar to user 101 and video game application 130 of FIG. 2. In some embodiments, the one or more settings corresponding to a user and/or video game application used and/or accessed by Assistance determination module 230 include accessibility settings that enable gameplay of the video game application to be more accessible to a user.

For example, when a user enables text to speech as an accessibility feature, the Indication determination system can be configured to select and/or prefer auditory and/or haptic output or rendering types for assist indications, as opposed to visual rendering types.

Assistance configuration module 240 of navigation assistance system 200 includes computer executable instructions configured to configure an assist indication for rendering. In some embodiments, assistance configuration modules 340 configures, generates, and/or produces an assist indication with one or more rendering and/or output types, such as auditory, visual, and/or haptic output.

An assist indication can be configured to provide audio rendering or output to one or more audio channels. Audio output or renderings corresponding to an assist indication can be configured to be distinguishable from other audio sounds and/or tracks that are also being rendered among the rendering of the virtual interactive environment. For example, audio of an assist indication can have a unique tone, frequency, pitch, duration, volume and/or other characteristics or properties of the like.

An assist indication can be configured to provide one or more visual renderings or output (e.g., post processing effects). Visual output or renderings corresponding to an assist indication can be configured to be distinguishable from other visuals and/or visual effects that are also being rendered (e.g., among the rendering of the virtual interactive environment). For example, visuals of an assist indication can have a unique color, tool, screen space location, intensity, duration, luminance, opacity and/or other characteristics or properties of the like.

An assist indication can be configured to provide haptic output to one or more haptic output channels (e.g., to particular haptic rotors or hardware devices). Haptic output or renderings corresponding to an assist indication can be configured to be distinguishable from other haptic output also being rendered or communicated to a hardware device. For example, haptics of an assist indication can have a unique intensity, frequency, duration, channel, and/or other characteristics or properties of the like.

In some embodiments, the assist indication configured by Assistance configuration module 240 is sent and/or provided to a game engine for rendering. The assist indication can include game data, such as data for rendering (e.g., render data), that instructs a game engine and/or video game application when and how the assist indication should be rendered to one or more input and/or output hardware devices.

### Assist Indication

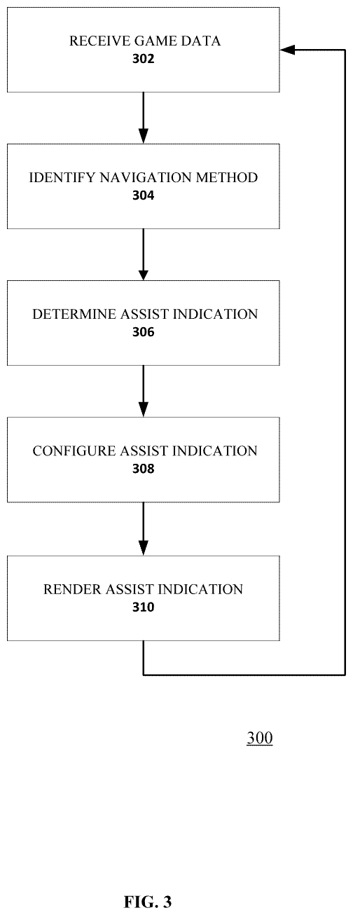

FIG. 3 is a flow diagram of a process to configure real-time assist indication systems according to an example embodiment. As described herein, assist indication can be provided in game sessions during gameplay of a video game. In some embodiments, process 300 corresponds to an assist indication system of a video game application during gameplay; similar to video game application 130, game session 131, and assist indication system 216 of FIG. 2.

At step 302, an assist indication system receives game data corresponding to a game session. In some embodiments, an assist indication system can access and/or request game data at one or more instances during gameplay. In some embodiments, the game data received is similar to game data 134 of FIG. 2.

In some embodiments, step 302 is performed by a receiving module similar to receiving module 210 of FIG. 3. In some embodiments, game data received at step 302 is captured and/or stored among one or more buffers or memory devices corresponding to a video game application and/or hardware device.

At step 304, an assist indication system identifies one or more navigation assists—or the corresponding data thereof-among the game data received.

For example, a path line—as a navigation assist-rendered among the virtual interactive environment during gameplay can be identified among the game data received. In some embodiments, identifying one or more navigation assists among the game data also includes identifying one or more properties and/or characteristics of the navigation assist.

In some embodiments, step 304 is performed by an identification module similar to identification module 220 of FIG. 3. As such, an assist indication system includes computer executable instructions that identify data among data as corresponding to a navigation assist. In some embodiments, data corresponding to the one or more navigation assists identified in step 304 are captured and/or stored among one or more buffers or memory devices corresponding to a video game application and/or hardware device.

At step 306, an assist indication system determines one or more assist indications, based at least in part on the game data received and/or the one or more navigation assists identified among the game data received.

In some embodiments, an assist indication determination can be made based on part one or more thresholds or criteria (hereinafter “assistance thresholds”). In some embodiments, meeting an assistance threshold corresponds to efficiently conveying contextual information, such as in relation to one or more states among the game data of a game session. For example, when an instance of a game session includes multiple audio tracks playing simultaneously, assist indication system 216 can be configured with deterministic logic to select and/or prefer a visual rendering type and/or a haptic rendering type over an audio rendering type to appropriate convey contextual information that can be distinguished from other rendered output.

In some embodiments, step 306 is performed by an assistance determination module similar to assistance determination module 230 of FIG. 3. In some embodiments, data corresponding to an assist indication determined in step 306 is captured and/or stored among one or more buffers or memory devices corresponding to a video game application and/or hardware device.

At step 308, an assist indication system configures one or more assist indications based in part on the game data received and/or the assist indication determination.

In some embodiments, configuring an assist indication includes the configuration of one or more properties or characteristics of the assist indication that correspond to its rendering. For example, the volume, tone, duration, frequency, and other characteristics relating to the rendering can also be based in part on game data corresponding to the speed and/or velocity of a player character, and the degree and/or curvature of the track ahead of a player character.

In some embodiments, configuring an assist indication can also be based in part on game data corresponding to one or more player characters and/or objectives. For example, when a player character is traversing a racetrack, an auditory assistance to a navigation assist-such as a path line
can be configured to render audio in among one or more audio channels to convey or indicate information corresponding to the racetrack that proceeds a player character and/or one or more other player characters among the racetrack.

In some embodiments, configuring an assist indication can also be based in part on a navigation assist and/or the corresponding game data thereof. The configuration of an assist indication can correspond to a particular portion or location of a navigation assist, herein known as an “assistance location”. An assistance location can correspond to a location or portion among a navigation assist to which the assist indication conveys contextual information about.

For example, a path line (as a navigation assist) corresponding to a racetrack among a virtual interactive can indicate that a player character should approach one of the sides of the racetrack to most efficiently make an upcoming turn; as such an assistance location among the path line can correspond to the turn such that an assist indication renders contextual information corresponding to the turn at one or more instances during gameplay, such as before a player character approaches the turn.

In some embodiments, an assistance location is determined based in part on game data, such as data corresponding to a player character, virtual interactive environment, objective, and/or navigation assist.

As such, one or more algorithms corresponding to the determination of an assistance location can be included among the video games. As known to a person of ordinary skill in the art, an algorithm corresponding to time, distance, and/or location between one or more locations and/or objects can be configured in a number of ways, including parameters and variables corresponding to speed, acceleration, velocity, friction, gravity, weight, force, drag coefficients, and slope, among other things. In some embodiments, the complexity of an algorithm can correspond to how one or more physics systems are configured in a video game. For example, in a simulation-based racing video game with a complex physics system or simulator, parameters and/or variables corresponding to the weight and drag coefficient of a player character vehicle may be included among one or more algorithms configured to determine an assistance location. As another example, in an arcade-based racing video with a simplistic physics system or simulator (e.g., that deviates from realistic simulation), the parameter and/or variables corresponding to speed and acceleration may be sufficient for determining an assistance location.

Therefore, game data corresponding to the speed and acceleration of vehicle, the length and curvature (i.e., corresponding tangents) of a path line, and the slope conditions of a racetrack among a virtual interactive environment, among other things, can be found and/or calculated for use among an algorithm corresponding to an assistance location determination.

As an illustrative example, an assistance location can be configured as being distance X from location A on a path line, where location A is the location on the path line closest to a player character. As another example, an assistance location can be configured as distance X directly from the player character. As another example, an assistance location can be at location X that is at a time Y ahead of the player character, based in part one or more characteristics, properties, or states of the player character and/or virtual interactive environment.

In some embodiments, an assist indication is configured based in part on one or more user configurable settings of a video game application, such as accessibility settings. For example, an assist indication system can exclude visual assist indication when colorblind accessibility settings or features are enabled. As another example, an assist indication system can be configured to provide only haptic assist indications when one or more hearing impairment accessibility settings or features are enabled.

In some embodiments, step 308 is performed by an assistance configuration module similar to assistance configuration module 240 of FIG. 3. In some embodiments, data corresponding to an assist indication determined in step 306 is captured and/or stored among one or more buffers or memory devices corresponding to a video game application and/or hardware device.

At step 310, an assist indication is rendered for output, such as among the rendering output corresponding to a game session. In some embodiments, an assist indication system provides and/or sends a game engine an assist indication—or corresponding render data thereof—for rendering.

The rendering of an assist indication conveys context and/or information about the game session (e.g., game state) that supplements a navigation assist. One advantage this provides is the ability to render an assist indication that is distinguishable from a navigation assist (e.g., of a different rendering type). Another advantage is that the rendering of an assist indication can indicate a sense of urgency. For example, the assistance can be rendered for at a particular frequency, intensity, or duration, among other things of the like, to convey a sense of urgency for performing one or more gameplay actions.

In some embodiments, process 300 occurs continuously and/or periodically over the course of a game session. As such, a video game application or corresponding software module can be configured to continuously and/or periodically monitor game data and re-perform one or more steps of process 300. For example, when game data among a game session updates-such as when a player character moves from the left to the right of a path line indication-one or more rendering types, and/or one or more characteristics of a path line indication can be changed, updated, or terminated, based in part on another determination among process 300.

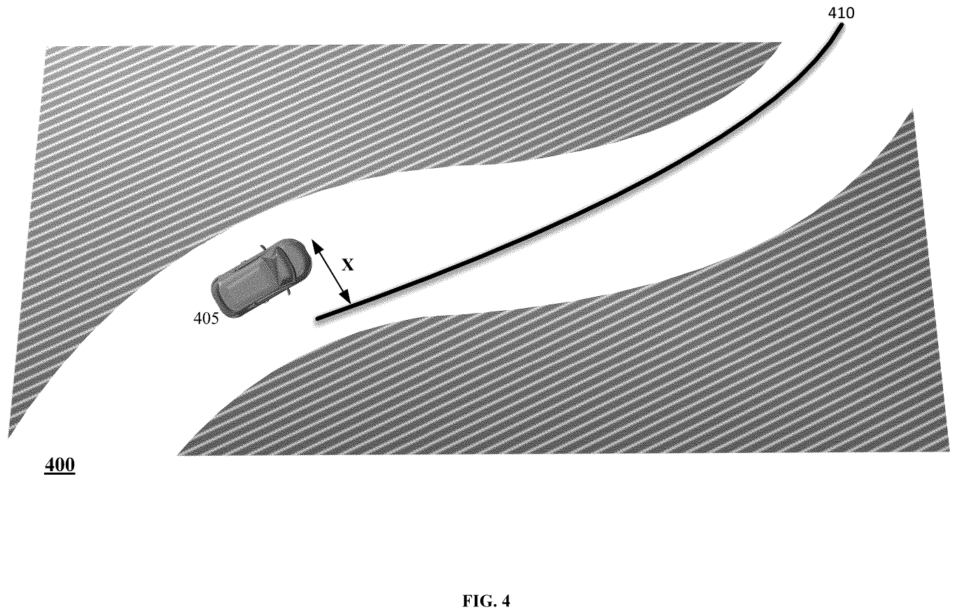

The steps and process of FIG. 4 can be associated to one or more hardware and/or software modules configured with computer-executable instructions. A person of ordinary skill in the art would recognize and appreciate how the proceeding process may be configured in a number of ways, such that one or more of steps are performed before, after, or simultaneously among other steps, and/or otherwise omitted or substituted in whole or in part.

FIG. 4 is a diagram of a virtual interactive environment 400 according to an example embodiment. illustrates an example embodiment of an assist indication for a path line navigation assist among virtual interactive environment 400. In some embodiments, virtual interactive environment 400 corresponds to a game session of a video game application, similar to game session 131 of video game application 130 from FIG. 2.

Virtual interactive environment 400 includes vehicle 405 and path line 410. As an illustrative example, virtual interactive environment 400 illustrates a racetrack, or portion thereof. In some embodiments, characteristics and/or states of virtual interactive environment 400 can change and/or vary within or among game sessions. Characteristics, states, and/or properties of virtual interactive environment 400 include weather conditions and materials, curvature, length, or width of the racetrack at one or more locations or instances, among other things.

Vehicle 405 is a player character represented as a vehicle among virtual interactive environment 400. In some embodiments, the vehicle-player character 405 is associated with a user account.

As an illustrative example, over the course of a game session (e.g., gameplay), vehicle 405 and/or virtual interactive environment 400 include and/or produce game data used by a game engine for rendering output; including rendering data, simulation data, and state data, among other things. In some embodiments, the game data includes, but is not limited to, (i) the characteristics and state of vehicle 405; such as the class or type of vehicle, the make and model, speed, location, and drag coefficient, among other things, and (ii) the characteristics or states of virtual interactive environment 400.

Path line 410 is a navigation assist along the racetrack of virtual interactive environment 400: illustrated as a partitioned or segmented line. In some embodiments, path line 410 is an adaptive race line that is produced during gameplay based in part on game data corresponding to virtual interactive environment 400 and vehicle 405.

As known to a person of ordinary skill in the art, an adaptive racing line is a dynamically rendered path line that conveys a path or optimal path among a racetrack, including one or more indications, such as color, corresponding to an optimal speed, acceleration, or deceleration at one or more instances along a path. For example, the curvature and color a path line along a racetrack in a virtual interactive environment can be based in part on game data corresponding to (i) the of player character—including, but not limited to, type, class, speed, direction, location, and acceleration—and (ii) the virtual interactive environment-such as the track and weather conditions.

An assist indication to path line 410 can be based in part on game data corresponding to a path line 410 and vehicle 405, such as distance X between them, among other things. In some embodiments, a path line indication provides an audio rendering corresponding to distance X. For instance, a path line indication as an auditory output rendering can produce audio based in part on the vehicle 405 location with respect to path line 410 (e.g., to the left of it). As such, to guide the user (e.g., vehicle 405) towards path line 410, a stereo sound output of the path line assist can produce sound from the right audio channel output of a stereo output, and without sound from the left audio channel. In turn, the rendered audio output would indicate—to a user—that vehicle 405 should move or turn towards the right to be more aligned with, or to approach, path line 410.

The output produced by a path line indication can be configured in a number of ways. The frequency, amplitude, duration, and other corresponding characteristics of the audio output can be configured to convey context corresponding more effectively to the state of the game (i.e., the game data).

For example, if vehicle 405 is moving at a high speed across virtual interactive environment 400, the audio output of a path line indication can be a rapid and high pitched sound emitted through the right audio channel, to indicate that vehicle 405 should move or turn towards the right rapidly. In contrast, and as another example, if vehicle 405 is moving slowly the corresponding output can be a slow and low tone to convey a lower sense of urgency.

Audio output of an assist indication is one of a number of assistance types or methods (i.e., rendering types) that can be used in a video game. In addition to audio, other in-game navigational assistance types or methods include, but are not limited to haptic feedback, graphical and/or visual renderings, post process effects, user interface elements, and prompts, among other things of the like. In some embodiments, an assist indication uses one or more rendering types to convey context more effectively.

For example, a navigational assistance can include a combination of haptic, visual, and auditory rendering types. As such, the intensity, frequency, luminosity, color, and other characteristics of each rendering type can vary, correspond, and/or adapt to game data of a game session to convey context more effectively and/or optimally. Furthermore, the one or more rendering types of navigational assists can be based in part on, or conform and/or comply with, one or more user configuration settings or accessibility settings of a video game.

In some embodiments, the context of a path line indication corresponds to one or more portions, sections, segments, or locations of path line 410. For example, a path line indication can convey context corresponding to a location of path line 410 at a designated distance from vehicle 405 or at a designated distance from the location of path line 410 closest to vehicle 405.

In some embodiments, a navigational assistance and/or assist indication can be communicated to a number of local or remote computing hardware devices communicatively coupled to a video game application. Therefore, a navigational assistance and/or assist indication may be communicated among a smart home network, such as smart devices, tables, speakers, lights, hubs, routers, and other devices of the like, by way of a corresponding software (i.e., an SDK) among a video game application that enables support for such communication. For example, audio output of a path line assistance can be communicated to a communicatively coupled smart device hub for playback or output on or more smart devices, such as a wireless speaker by way of corresponding software.

### Example Computing Device

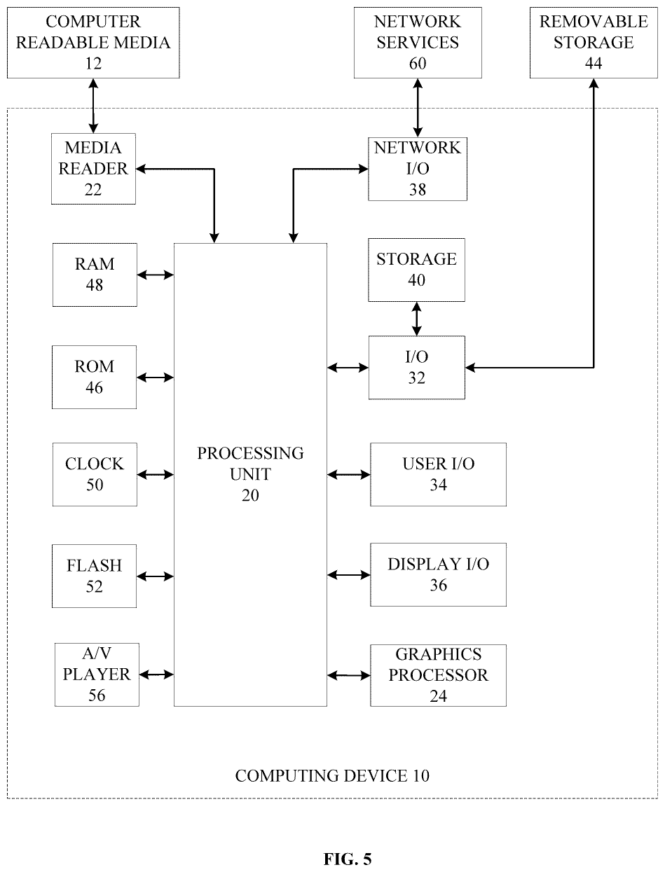

FIG. 5 is a diagram of an example computing device usable to perform any of the methods described herein, including for real-time assist indication. In particular, FIG. 5 illustrates example computing resources within a computing device 10. In some embodiments, some or all of the aforementioned hardware devices-such as computing devices 110 of FIG. 1—are similar to computing device 10, as known to those of skill in the art.

Other variations of the computing device 10 may be substituted for the examples explicitly presented herein, such as removing or adding components to the computing device 10. The computing device 10 may include a video game console, a smart phone, a tablet, a personal computer, a laptop, a smart television, a server, and the like.

As shown, the computing device 10 includes a processing unit 20 that interacts with other components of the computing device 10 and external components. A media reader 22 is included that communicates with computer readable media 12. The media reader 22 may be an optical disc reader capable of reading optical discs, such as DVDs or BDs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network. Network I/O 38 may be used during execution, such as when a client is connecting to a server over a network.

Display output signals produced by display I/O 36 comprising signals for displaying visual content produced by computing device 10 on a display device, such as graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such as display 16.

The computing device 10 can also include other features, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in ROM 46, RAM 48, or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The disclosed subject matter also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The disclosed subject matter may be provided as a computer program product, or software, that may include a machine-readable medium having stored thereon instructions, which may be used to program a computer system (or other electronic devices) to perform a process according to the disclosed subject matter. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

One set of example embodiments of the disclosure can be described by the following clauses:

Clause 1. A system comprising: at least one processor; and at least one memory device, wherein the at least one memory device is communicatively coupled to the at least one processor, the at least one memory device storing computer-executable instructions, wherein execution of the computer-executable instructions by the at least one processor causes the at least one processor to: receive game data of a game session in a virtual interactive environment, the game data including at least user configuration data and a location of a virtual object on a virtual path within the virtual interactive environment; identify a navigation assist corresponding to the virtual path based on the game data; determine, based in part on the game data and the navigation assist, an assist indication type from among a plurality of assist indication types; determine a configuration of an assist indication based at least in part on the game data, the assist indication type, and the user configuration data; generate the assist indication based on the configuration of the assist indication; and output, during gameplay, the assist indication corresponding to the virtual path of the virtual interactive environment of the game session.

Clause 2. The system of clause 1, wherein the plurality of assist indication types include auditory, visual, and haptic rendering.

Clause 3. The system of clause 1, wherein the user configuration data includes one or more accessibility settings.

Clause 4. The system of clause 1, wherein the output of the assist indication is an auditory rendering of at least one of channel, direction, duration, intensity, frequency, tone, or volume.

Clause 5. The system of clause 1, wherein the output of the assist indication is a haptic signal output, the haptic signal output including signal data including at least one of duration, intensity, or frequency.

Clause 6. The system of clause 1, wherein the output of the assist indication is a visual rendering.

Clause 7. The system of clause 1, wherein one or more characteristics of the output of the assist indication is based in part on a distance between the virtual object and the virtual path.

Clause 8. A computer implemented method comprising: receiving game data of a game session in a virtual interactive environment, the game data including at least user configuration data and a location of a virtual object on a virtual path within the virtual interactive environment; identifying a navigation assist corresponding to the virtual path based on the game data; determining, based in part on the game data and the navigation assist, an assist indication type from among a plurality of assist indication types; determining a configuration of an assist indication based at least in part on the game data, the assist indication type, and the user configuration data; generating the assist indication based on the configuration of the assist indication; and outputting, during gameplay, the assist indication corresponding to the virtual path of the virtual interactive environment of the game session.

Clause 9. The method of clause 8, wherein the plurality of assist indication types include auditory, visual, and haptic rendering.

Clause 10. The method of clause 8, wherein the user configuration data includes one or more accessibility settings.

Clause 11. The method of clause 8, wherein the output of the assist indication is an auditory rendering of at least one of channel, direction, duration, intensity, frequency, tone, or volume.

Clause 12. The method of clause 8, wherein the output of the assist indication is a haptic signal output, the haptic signal output including signal data including at least one of duration, intensity, or frequency.

Clause 13. The method of clause 8, wherein the output of the assist indication is a visual rendering.

Clause 14. The method of clause 8, wherein one or more characteristics of the output of the assist indication is based in part on a distance between the virtual object and the virtual path.

Clause 15. A non-transitory computer readable medium storing computer-executable instructions, wherein, when executed, the computer-executable instructions configure at least one processor to: receive game data of a game session in a virtual interactive environment, the game data including at least user configuration data and a location of a virtual object on a virtual path within the virtual interactive environment; identify a navigation assist corresponding to the virtual path based on the game data; determine, based in part on the game data and the navigation assist, an assist indication type from among a plurality of assist indication types; determine a configuration of an assist indication based at least in part on the game data, the assist indication type, and the user configuration data; generate the assist indication based on the configuration of the assist indication; and output, during gameplay, the assist indication corresponding to the virtual path of the virtual interactive environment of the game session

Clause 16. The non-transitory computer readable medium of clause 15, wherein the plurality of assist indication types include auditory, visual, and haptic rendering.

Clause 17. The non-transitory computer readable medium of clause 15, wherein the user configuration data includes one or more accessibility settings.

Clause 18. The non-transitory computer readable medium of clause 15, wherein the output of the assist indication is an auditory rendering of at least one of channel, direction, duration, intensity, frequency, tone, or volume.

Clause 19. The non-transitory computer readable medium of clause 15, wherein the output of the assist indication is a haptic signal output, the haptic signal output including signal data including at least one of duration, intensity, or frequency.

Clause 20. The non-transitory computer readable medium of clause 15, wherein the output of the assist indication is a visual rendering.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

What is claimed is:

1. A system comprising:
at least one processor; and
at least one memory device, wherein the at least one memory device is communicatively coupled to the at least one processor, the at least one memory device storing computer-executable instructions, wherein execution of the computer-executable instructions by the at least one processor causes the at least one processor to:
receive game data of a game session in a virtual interactive environment, the game data including at least user configuration data and a location of a virtual object on a virtual path within the virtual interactive environment;
identify a navigation assist corresponding to the virtual path based on the game data;
determine, based in part on the game data and the navigation assist, an assist indication type from among a plurality of assist indication types;
determine a configuration of an assist indication based at least in part on the game data, the assist indication type, and the user configuration data;
generate the assist indication based on the configuration of the assist indication; and
output, during gameplay, the assist indication corresponding to the virtual path of the virtual interactive environment of the game session.

2. The system of claim 1, wherein the plurality of assist indication types include auditory, visual, and haptic rendering.

3. The system of claim 1, wherein the user configuration data includes one or more accessibility settings.

4. The system of claim 1, wherein the output of the assist indication is an auditory rendering of at least one of channel, direction, duration, intensity, frequency, tone, or volume.

5. The system of claim 1, wherein the output of the assist indication is a haptic signal output, the haptic signal output including signal data including at least one of duration, intensity, or frequency.

6. The system of claim 1, wherein the output of the assist indication is a visual rendering.

7. The system of claim 1, wherein one or more characteristics of the output of the assist indication is based in part on a distance between the virtual object and the virtual path.

8. A computer implemented method comprising:
receiving game data of a game session in a virtual interactive environment, the game data including at least user configuration data and a location of a virtual object on a virtual path within the virtual interactive environment;
identifying a navigation assist corresponding to the virtual path based on the game data;
determining, based in part on the game data and the navigation assist, an assist indication type from among a plurality of assist indication types;
determining a configuration of an assist indication based at least in part on the game data, the assist indication type, and the user configuration data;
generating the assist indication based on the configuration of the assist indication; and
outputting, during gameplay, the assist indication corresponding to the virtual path of the virtual interactive environment of the game session.

9. The method of claim 8, wherein the plurality of assist indication types include auditory, visual, and haptic rendering.

10. The method of claim 8, wherein the user configuration data includes one or more accessibility settings.

11. The method of claim 8, wherein the output of the assist indication is an auditory rendering of at least one of channel, direction, duration, intensity, frequency, tone, or volume.

12. The method of claim 8, wherein the output of the assist indication is a haptic signal output, the haptic signal output including signal data including at least one of duration, intensity, or frequency.

13. The method of claim 8, wherein the output of the assist indication is a visual rendering.

14. The method of claim 8, wherein one or more characteristics of the output of the assist indication is based in part on a distance between the virtual object and the virtual path.

15. A non-transitory computer readable medium storing computer-executable instructions, wherein, when executed, the computer-executable instructions configure at least one processor to:
receive game data of a game session in a virtual interactive environment, the game data including at least user configuration data and a location of a virtual object on a virtual path within the virtual interactive environment;
identify a navigation assist corresponding to the virtual path based on the game data;
determine, based in part on the game data and the navigation assist, an assist indication type from among a plurality of assist indication types;
determine a configuration of an assist indication based at least in part on the game data, the assist indication type, and the user configuration data;
generate the assist indication based on the configuration of the assist indication; and
output, during gameplay, the assist indication corresponding to the virtual path of the virtual interactive environment of the game session

16. The non-transitory computer readable medium of claim 15, wherein the plurality of assist indication types include auditory, visual, and haptic rendering.

17. The non-transitory computer readable medium of claim 15, wherein the user configuration data includes one or more accessibility settings.

18. The non-transitory computer readable medium of claim 15, wherein the output of the assist indication is an auditory rendering of at least one of channel, direction, duration, intensity, frequency, tone, or volume.

19. The non-transitory computer readable medium of claim 15, wherein the output of the assist indication is a haptic signal output, the haptic signal output including signal data including at least one of duration, intensity, or frequency.

20. The non-transitory computer readable medium of claim 15, wherein the output of the assist indication is a visual rendering.
